(19) United States
(12) Patent Application Publication
(10) Pub. No.: US 2017/0073497 A1
(43) Pub. Date: Mar. 16, 2017

(54) Antioxidant Compositions

(71) Applicant: Addivant Switzerland GmbH, Reinach (CH)

(72) Inventors: Hayder Zahalka, Reinach (CH); Maurice Power, Reinach (CH); Jonathan Hill, Reinach (CH)

(21) Appl. No.: 15/123,342

(22) PCT Filed: Feb. 20, 2015
(86) PCT No.: PCT/EP2015/053663

§ 371 Date: Sep. 2, 2016

(30) Foreign Application Priority Data
Mar. 3, 2014 (GB) 1403714.7

(51) Int. Cl. C08K 5/18; C08K 5/00; C08K 5/101

(52) U.S. Cl. CPC C08K 5/18; C08K 5/101; C08K 5/005

(57) ABSTRACT

The invention provides a stabilising composition for polymeric materials comprising: at least one secondary arylamine having the formula I:

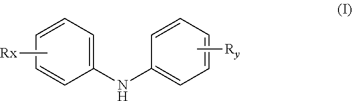

wherein:
the or each R, which may be the same or different, independently denotes an optionally substituted hydrocarbyl group having at least 5 carbon atoms;
x and y are each independently from 0 to 5 provided that at least one of x and y is at least 1; and
a phenolic antioxidant,
the composition and/or the secondary arylamine being a liquid at ambient conditions substantially free from diphenylamine and/or from lower alkylated diphenylamine antioxidants.

### CROSS REFERENCE TO RELATED APPLICATIONS

This application is a U.S. national phase filing of PCT international patent application No. PCT/EP2015/053663, with a filing date of Feb. 20, 2015, which in turn claims the benefit of British patent application serial number 1403714.7, filed Mar. 3, 2014, the disclosures of which are expressly incorporated by reference.

### FIELD

The present invention relates to antioxidant compositions. The antioxidant compositions are, in particular though not exclusively, useful for the stabilisation of polyols and polyurethanes, including polyurethane foams.

Polyurethanes constitute a class of polymers with a range of structures, properties and applications. They all have carbamate or urethane linkages (—NH—C(═O)—O—) and can be made by reacting isocyanates with polyols. They can be tailored according to the choice of isocyanate and polyol, the presence of other component(s), and the reaction conditions. Polyurethanes include thermoplastic materials and thermosetting materials, and are used to produce flexible and rigid foams, coatings, fibres, moulded products, elastomeric components, seals and adhesives, amongst other products.

Polyurethanes are susceptible to degradation over time. Preparation or processing of the polyurethanes can also bring about or enhance degradation. The main cause of degradation, as with many other organic materials, is reaction with oxygen in a free radical autoxidation cycle. The formation of free radicals can be triggered or enhanced by exposure to heat or radiation (particularly UV light), or reaction of polymer with other components or impurities. The free radicals then react with oxygen to form peroxy radicals. The peroxy radicals react with further polymer to produce hydroperoxides, which themselves decompose to result in further reactive free radical species.

Antioxidants can be used to break the degradation cycle. Some antioxidants, known as primary antioxidants, are designed to react with peroxy radicals. Other antioxidants, known as secondary antioxidants, are designed to react with hydroperoxides.

Types of primary antioxidants include sterically hindered phenols and secondary arylamines, e.g. as disclosed in U.S. Pat. No. 4,824,601. It is known to use these two types in combination for the stabilisation of polyurethanes. For example, Ciba Speciality Chemicals have marketed blends of the sterically hindered phenol “Irganox 1135”, having the following structure wherein R denotes C7 to C9 alkyl:

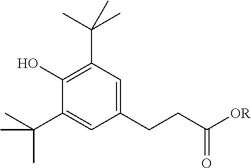

with the secondary arylamine “Irganox 5057”, having the following structure wherein each R independently denotes butyl, octyl, other alkyl chains, or H:

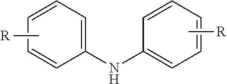

Unfortunately, these and other blends exhibit fogging issues.

There is a need for improved antioxidant compositions, in particular liquid antioxidant compositions, which provide effective stabilisation and at the same time avoid or reduce fogging.

### SUMMARY

We have developed a specific combination of components which provides improved results.

According to a first aspect of the present invention there is provided a stabilising composition for polymeric materials, comprising: at least one secondary arylamine having the formula I:

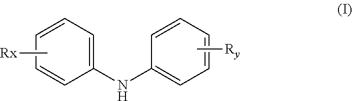

wherein:
the or each R, which may be the same or different, independently denotes an optionally substituted hydrocarbyl group having at least 5 carbon atoms;
x and y are each independently from 0 to 5 provided that at least one of x and y is at least 1; and
a phenolic antioxidant,
the composition and/or the secondary arylamine being a liquid at ambient conditions and being substantially free from diphenylamine and/or from lower alkylated diphenylamine antioxidants.

By “ambient conditions” we mean preferably a temperature of 50° C. or lower, more preferably a temperature of 30° C. or lower and most preferably a temperature of 25° C. or lower, and atmospheric pressure i.e. 101.325 kPa. For example, in one embodiment, “ambient conditions” means a temperature of 25° C. and atmospheric pressure.

Preferably both the phenolic antioxidant and the secondary arylamine are liquid at ambient conditions. However, in some cases it is possible to create a composition according to the invention which is liquid at ambient conditions by blending a liquid phenolic antioxidant with a solid secondary arylamine.

The optionally substituted hydrocarbyl group has at least 5 carbon atoms and thus, may be considered a “higher” hydrocarbyl group. Preferably the optionally substituted hydrocarbyl group has at least 6 carbon atoms, more preferably at least 7 carbon atoms, yet more preferably at least 8 carbons atoms, and most preferably at least 9 carbon atoms.

By “lower alkylated diphenylamine” we mean preferably materials having the same general structure set out in formula I, except in which preferably x=y=1 and wherein R represents a lower hydrocarbyl group (each R being the same or different); “lower” in this connection meaning C4 and below, C₃ and below, C₂ and below or C₁.

In the above connection the stabilising composition of the invention is preferably substantially free from diphenylamine and from lower alkylated diphenylamine antioxidants. For example, the stabilising composition may be substantially free from t-butylated diphenylamines.

The polymeric materials may be for example polyether polyols used in the production of polyurethanes, for example flexible and semiflexible polyurethane foams, or polyurethanes themselves.

In formula I, and provided that at least one of x and/or y is more than zero, x and y are preferably each independently from 0 to 4, more preferably from 0 to 3, still more preferably from 0 to 2, and most preferably 1. In some embodiments, x and y are the same, and may both be 1.

The hydrocarbyl groups may be aliphatic hydrocarbyl groups. Preferably the aliphatic hydrocarbyl groups are selected from alkyl, alkenyl and alkynyl, and may in each case be substituted with other functional groups, or contain other functional linkages, which may include heteroatoms.

More preferably, the hydrocarbyl groups are optionally substituted alkyl groups.

In this specification “alkyl” includes cycloalkyl and both straight and branched chain alkyl.

The or each hydrocarbyl group may comprise an alkaryl or aralkyl group and consequently may include or be substituted with one or more aryl groups, for example phenyl groups.

The stabilising composition of the invention is preferably substantially free from secondary or tertiary arylamines having vapour pressures above 0.03 Pa at 20° C. Diphenylamine for example has a vapour pressure of 0.033Pa at 20° C.

By “substantially free” we mean with respect to an individual component that that component is present (if at all) in an amount of preferably less than 2% w/w, more preferably less than 1.5% w/w, still more preferably less than 1.0% w/w, yet more preferably less than 0.5% w/w, and most preferably less than 0.2% w/w of the stabilising composition. Alternatively we mean that the total amount of any such components is less than 2% w/w, more preferably less than 1.5% w/w, still more preferably less than 1.0%, yet more preferably less than 0.5% w/w, and most preferably less than 0.2% w/w of the stabilising composition.

When only one R group is present on an aromatic ring in formula I, that R group is preferably provided in the position ortho or para to the amine linkage.

The upper limit to the number of carbon atoms in the hydrocarbyl group of the secondary arylamine of formula I depends on the requirement for the stabilising composition to be a liquid at ambient conditions and may depend on the practical availability of materials. One particularly preferred secondary arylamine contains two C₉ aliphatic hydrocarbyl groups, one on each aromatic ring, for example the nonylated diphenylamine.

Other secondary arylamines may be present in the blend of the invention but when present are preferably selected with regard to their volatility to avoid the aforementioned problem of fogging, and also to ensure that the stabilising composition is a liquid.

Without wishing to be bound by theory, it is believed that lower molecular weight and/or more volatile compounds may be responsible for fogging. Many antioxidant products and indeed other additives are nominally referred to as a particular compound but often contain a mixture of compounds. For example, predominantly octylated diphenylamine products such as Irganox® 5057 may also comprise other alkylated diphenylamine compounds including in particular di- and monobutylated diphenylamine, and it is thought that monobutylated diphenylamine in particular gives rise to fogging problems.

The presence of a range of compounds can be due to the preparation processes, for example as described in U.S. Pat. No. 4,824,601.

The second essential component of the stabilising composition of the invention is a phenolic antioxidant.

The phenolic antioxidants provided in the stabilising composition of the invention are selected such that the stabilising composition is liquid at ambient conditions as described above. Often this will be achieved by selecting individual phenolic antioxidant components which are themselves liquid at ambient conditions.

Preferably the phenolic antioxidant comprises a phenol group which is substituted, preferably substituted twice, preferably at positions ortho to the —OH group in the phenol. The or each, but preferably both, substituents may comprise alkyl groups, of which branched chain alkyl groups and particularly t-butyl groups are preferred.

The phenolic antioxidant may have a molecular weight of at least about 390, at least about 400, at least about 410, at least about 420, at least about 430, at least about 440, at least about 450, at least about 460, at least about 470 or at least about 480.

The inventors of the present invention have found that by carefully selecting at least one phenolic antioxidant with a molecular weight as described above, an improved stabilising composition which is liquid at ambient conditions can be achieved. Preferably, the phenolic antioxidant is liquid at ambient conditions. Further preferably, the phenolic antioxidant has a molecular weight of at least about 390. By way of specific and non-limiting example, such phenolic antioxidants may for example be selected from one or more of 2,2′thiodiethylene bis[3(3,5-di-t-butyl-4-hydroxyphenyl)propionate] (Anox® 70—CAS 41484-35-9); C13-C15 linear and branched alkyl esters of 3-(3′5′-di-t-butyl-4′-hydroxyphenyl) propionic acid (Anox® 1315—CAS 171090-93-0); 1,3,5-trimethyl-2,4,6-tris(3,5-di-t-butyl-4-hydroxybenzyl)benzene (Anox® 330—CAS 1709-70-2); C9-C11 linear and branched alkyl esters of 3-(3′,5′-di-t-butyl-4′-hydroxyphenyl)propionic acid (Naugard® PS48—CAS 125643-61-0); triethyleneglycol-bis-[3-(3-t-butyl-4-hydroxy-5-methylphenyl)propionate] (Lowinox® GP45—CAS 36443-68-2); alpha-tocopherol; and/or compatible mixtures of two or more thereof.

However, the phenolic antioxidant may not necessarily comprise a single material but may instead itself comprise a suitable blend of materials. In that case it may be possible to include in the blend one or more phenolic antioxidants which are not themselves liquid at ambient conditions but which nevertheless may be blended with one or more other compatible liquid antioxidants to yield a blend which is itself liquid at ambient conditions. Again, it may be preferable for such phenolic antioxidants to have a molecular weight of at least about 390. Specific, non-limiting examples of such phenolic antioxidants include tetrakismethylene(3,5-di-t-butyl-4-hydroxy hydrocinnamate) methane (Anox® 20—CAS 6683-19-8); octadecyl 3-(3′,5′-di-t-butyl-4′-hydroxyphenyl) propionate (Anox® PP18—CAS 2082-79-3); 1,3,5-tris(3,5-di-t-butyl-4-hydroxybenzyl) isocyanurate (Anox® IC14—CAS 27676-62-6); N,N′-hexamethylene bis[3-(3,5-di-t-butyl-4-hydroxyphenyl)propionamide] (Lowinox® HD98—CAS 23128-74-7); 1,2-bis(3,5-di-t-butyl-4-hydroxyhydrocinnamoyl)hydrazine (Lowinox® MD24—CAS 32687-78-8); the butylated reaction product of p-cresol and dicyclopentadiene (Lowinox® CPL—CAS 68610-51-5); 2,2′-ethylidenebis[4,6-di-t-butylphenol] (Anox® 29—CAS 35958-30-6); and/or compatible mixtures of two or more thereof.

One particularly preferred phenolic antioxidant comprises C13-C15 linear and branched alkyl esters of 3-(3′5′-di-t-butyl-4′-hydroxyphenyl) propionic acid (Anox® 1315—CAS 171090-93-0).

The phenolic antioxidant may additionally or alternatively comprise one or more phenolic antioxidants with a lower molecular weight than those described above i.e. a molecular weight of less than about 390. As has been emphasised, the antioxidants provided in the stabilising composition of the invention are selected to provide liquid blends at ambient conditions. Often this will be achieved by selecting individual antioxidant components which are themselves liquid at ambient conditions. By way of specific and non-limiting examples, such antioxidants may comprise: 2-(1,1-dimethylethyl)-4,6-dimethyl-phenol (Lowinox® 624—CAS 1879-09-0); 2-tert-butyl-5-methylphenol; and/or compatible mixtures thereof.

It may be possible to include in the blend one or more phenolic antioxidants with a molecular weight of less than about 390, which are not themselves liquid at ambient conditions but which nevertheless may be blended with one or more other compatible liquid antioxidants to yield a blend which is itself liquid at ambient conditions. Specific, non-limiting examples of such materials include: 2,2′methylenebis(6-t-butyl-4-methylphenol) (Lowinox® 22M46—CAS 119-47-1), butylated hydroxytoluene (BHT—CAS 128-37-0), 4,6-di-tert-butyl-2-methylphenol, 6-tert-butyl-2-methylphenol, 2-tert-butyl-4-methylphenol, 2-tert-butyl-5-methylphenol, 2,4-di-tert-butylphenol, 2,4-di-tert-pentylphenol, 4-tert-pentyphenol, and 2,6-xylenol (which may be less preferred owing to its toxicity).

According to a second aspect of the present invention there is provided a composition comprising a polyol and the above-mentioned stabilising composition.

According to a third aspect of the present invention there is provided a composition comprising a polyurethane and the above-mentioned stabilising composition.

According to a fourth aspect of the present invention there is provided a process comprising incorporating or applying the above mentioned stabilising composition to a polyurethane or its precursors.

According to a fifth aspect of the present invention there is provided a process for producing a polyurethane, comprising adding the above-mentioned stabilising composition to a polyol and subsequently reacting with isocyanate to form a polyurethane.

According to a sixth aspect of the present invention there is provided the use of the above-mentioned stabilising composition for stabilising a polyol or polyurethane.

The stabilisation may be against oxidative, thermal and/or radiation (e.g. light, e.g. UV light) induced degradation.

The invention will now be more particularly described with reference to the following non-limiting examples.

### EXAMPLES

Table 1 outlines details relating to different stabilising components. Hereinafter, the stabilising components will simply be referred to using the name given in the ‘component’ column.

TABLE 1

| Component | CAS No. | Description |
|---|---|---|
| Anox^{RTM} | 171090-93-0 | C13-C15 linear and branched alkyl |
| 1315 | | esters of 3-(3′-5′-di-t-butyl-4′- |
| | | hydroxylphenyl)propionic |
| | | acid |
| Anox^{RTM} 20 | 6683-19-8 | Tetrakismethylene(3,5-di-t-butyl-4- |
| | | hydroxyhydrocinnamate)methane |
| Naugard^{RTM} | 125643-61-0 | C7-C9 branched alkyl ester of 3,5-di- |
| PS48 | | tert-butyl-4-hydroxyhydrocinnamic acid |
| Naugard^{RTM} | 68411-46-1 | Diphenylamine C4/C8 reaction product |
| PS30 | | |
| NL438L | 36878-20-3 | Diphenylamine C9 reaction product |

### Examples 1 to 3

Differential Scanning calorimetry (DSC) analysis was carried out on three polyether polyol samples. The polyether polyol was commercially available and had an average molecular weight of 3500 and a hydroxyl number of 48 mg KOH/g.

The first sample acted as a control and had no stabilising components added thereto (Example 1). The second sample had 0.6% w/w of a stabilising composition formed from Anox® 1315 and NL438L in a ratio of 2:1 added thereto (Example 2). The third sample had 0.6% w/w of a stabilising composition formed from Naugard® PS48 and Naugard® PS30 in a ratio of 2:1 added thereto and acted as a comparative example (Example 3).

Differential Scanning calorimetry (DSC) was used to measure the oxidation onset temperature for each of the samples. The results are shown in Table 2.

TABLE 2

| Example | Oxidation Temperature (° C.) |
|---|---|
| 1 | 144 |
| 2 | 206 |
| 3 | 207 |

It can be seen from the results that the stabilising composition according to the present invention dramatically improves the polyether polyol stability against oxidative degradation compared to the polyether polyol without any stabilising composition, and is directly comparable (within experimental error) to the polyether polyol with lower alkyl reaction products of diphenylamine.

### Examples 4 to 6

Three polyurethane foam samples were formed in a 25 cm×25 cm×25 cm box. Each polyurethane foam sample had the composition outlined in Table 3.

TABLE 3

| Component | Parts |
|---|---|
| Polyether polyol | 100.00 |
| Silicone | 0.75 |
| Tin catalyst | 0.25 |
| Amine catalyst | 0.20 |
| TDI 80 | 78.55 |
| Water | 6.00 |

The first foam sample acted as a control and had no stabilising components added thereto (Example 4). The second foam sample had 0.6% w/w of a stabilising composition formed from Anox® 1315 and NL438L in a ratio of 2:1 added thereto (Example 5). The third foam sample had 0.6% w/w of a stabilising composition formed from Naugard® PS48 and Naugard® PS30 in a ratio of 2:1 added thereto and acted as a comparative example (Example 6).

Colour change or development of the samples was measured by heating each sample in an oven at 180° C. for 60 minutes and then measuring Yellowness Index (YI) according to ASTM D1925. The results are shown in Table 4.

TABLE 4

| Example | Yellowness Index |
|---|---|
| 4 | 53.8 |
| 5 | 4.3 |
| 6 | 5.3 |

From the results it can clearly be seen that the stabilising composition according to the present invention dramatically reduces the colour change of the polyurethane foam compared to non-stabilised compositions. Additionally, it can be seen that the stabilising composition according to the present invention significantly reduces the colour degradation of the polyurethane foam compared to that stabilised by the composition formed from Naugard® PS48 and Naugard® PS30.

### Examples 7 and 8

Microwave scorch data was measured for two polyurethane foam samples having the composition outlined in Table 3. The first foam sample had 0.6% w/w of a stabilising composition formed from Anox® 1315 and NL438L in a ratio of 2:1 added thereto (Example 7). The second foam sample had 0.6% w/w of a stabilising composition formed from Naugard® PS48 and Naugard® PS30 in a ratio of 2:1 added thereto and acted as a comparative example (Example 8).

The microwave scorch data was measured as delta E, according to the standard test method ASTM D1925. The results are shown in Table 5.

TABLE 5

| Example | Delta E |
|---|---|
| 7 | 32.2 |
| 8 | 31.8 |

### Examples 9 to 11

The amount of volatile organic compounds (VOCs) was measured for three polyurethane foam samples having the composition outlined in Table 3.

The first foam sample acted as a control and had no stabilising components added thereto (Example 9). The second foam sample had 0.6% w/w of a stabilising composition formed from Anox® 1315 and NL438L in a ratio of 2:1 added thereto (Example 10). The third foam sample had 0.6% w/w of a stabilising composition formed from Naugard® PS48 and Naugard® PS30 in a ratio of 2:1 added thereto and acted as a comparative example (Example 11).

The amount of VOCs was measured according to standard test method VDA 278. And emission causing fogging was quantified. The results are shown in Table 6.

TABLE 6

| Example | VOC (ppm) | FOG (ppm) |
|---|---|---|
| 9 | 58 | 32 |
| 10 | 48 | 32 |
| 11 | 101 | 216 |

From the results it can be seen that the stabilising composition according to the present invention (Example 10) dramatically reduces the amount of VOC and FOG in the polyurethane foam compared to the stabilising composition formed from Naugard® PS48 and Naugard® PS30 (Example 11).

### Examples 12 to 17

An investigation into the physical properties of a stabilising composition according to the present invention compared to those of a current commercial stabilising composition was carried out.

A sample of a stabilising composition formed from Anox® 1315 and NL438L in a ratio of 2:1 was prepared (Example 12). As a comparative example, a composition formed from Naugard® PS48 and Naugard® PS30 was used (Example 13).

The viscosity of each of the samples was tested at temperatures ranging from 10° C. to 30° C.

The results are shown in Table 7.

TABLE 7

| Temperature | Viscosity (cPs) | Viscosity (cPs) |
|---|---|---|
| (° C.) | Example 12 | Example 13 |
| 10 | 2896 | 6336 |
| 15 | 1610 | 2925 |
| 20 | 941 | 1478 |
| 30 | 368 | 447 |

From the results it can be seen that the stabilising composition according to the present invention (Example 12) exhibited lower viscosities at all temperatures tested, compared to the current commercial stabilising composition (Example 13). This suggests that the stabilising composition according to the present invention would be easier to handle in plant, particularly at lower temperatures.

A sample of a stabilising composition formed from Anox® 1315 and NL438L in a ratio of 2:1 was prepared (Example 14). As a comparative example, composition formed from Naugard® PS48 and Naugard® PS30 (Example 15). Each of the stabilising compositions were tested to determine their ‘pour point’. The pour point of a liquid may be defined as the temperature at which the liquid becomes a semi-solid and thus, loses its flow characteristics.

The pour points were determined using standard test method ISO3016. The results are shown in Table 8.

TABLE 8

| Example | Pour Point (20 C.) |
|---|---|
| 14 | −6 |
| 15 | 0 |

From the results it can be seen that the stabilising composition according to the present invention (Example 14) remains pourable to a lower temperature compared to the current commercial stabilising composition (Example 15). This may suggest that the stabilising composition according to the present invention would be easier to handle in plant.

A sample of a stabilising composition formed from Anox® 1315 and NL438L in a ratio of 2:1 was prepared (Example 16). As a comparative example, composition formed from Naugard® PS48 and Naugard® PS30 (Example 17). Each of the stabilising compositions were subjected to thermal gravimetric analysis (TGA). The results are shown in Table 9.

TABLE 9

| | Example 16 | Example 17 |
|---|---|---|
| Atmosphere | N₂ | N₂ |
| Temp at 5% weight loss (° C.) | 254 | 218 |
| Temp at 10% weight loss (° C.) | 280 | 240 |
| Temp at 20% weight loss (° C.) | 304 | 261 |
| Temp at 50% weight loss (° C.) | 335 | 290 |

From the results it can be seen that the stabilising composition according to the present invention (Example 16) is stable to higher temperatures than the current commercial stabilising composition (Example 17).

### Examples 18 to 20

Three low density polyurethane foam samples were formed in a 25 cm×25 cm×25 cm box. Each of the polyurethane foam samples had the composition outlined in Table 3 and had a density of about 20 kg/m³.

The first foam sample acted as a control and had no stabilising components added thereto (Example 18). The second foam sample had 0.6% w/w of a stabilising composition formed from Anox® 1315 and NL438L in a ratio of 2:1 added thereto (Example 19). The third foam sample had 0.6% w/w of a stabilising composition formed from composition formed from Naugard® PS48 and Naugard® PS30 added thereto, and acted as a comparative example (Example 20).

The amount of volatile organic compounds (VOCs) attributed to the stabilizing compositions were measured for each of the polyurethane foam samples. The amount of VOCs and FOG were measured according to standard test method VDA 278. The results are shown in Table 11.

TABLE 11

| Example | VOC (ppm) | FOG (ppm) |
|---|---|---|
| 18 | 0 | 0 |
| 19 | 0 | 0 |
| 20 | 43 | 184 |

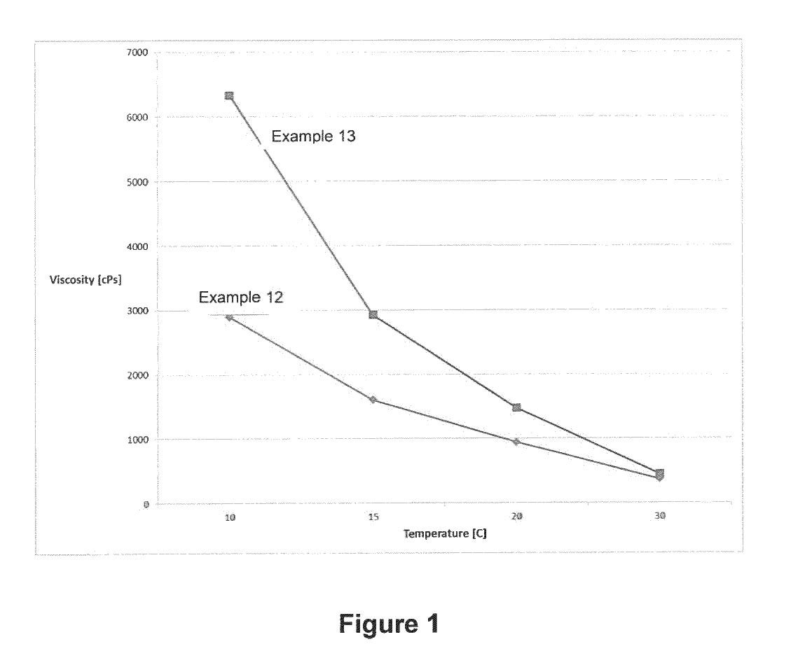

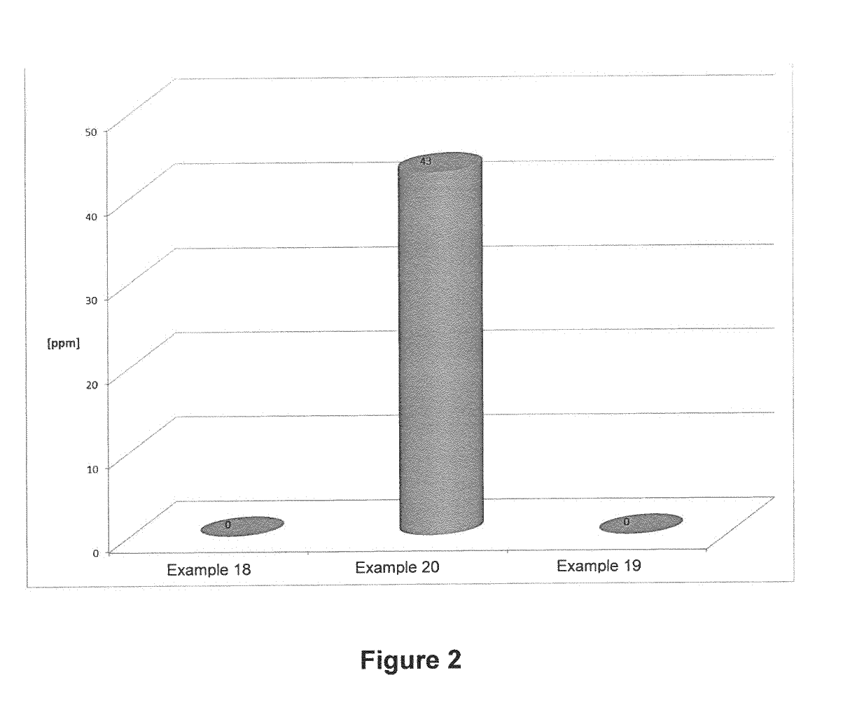

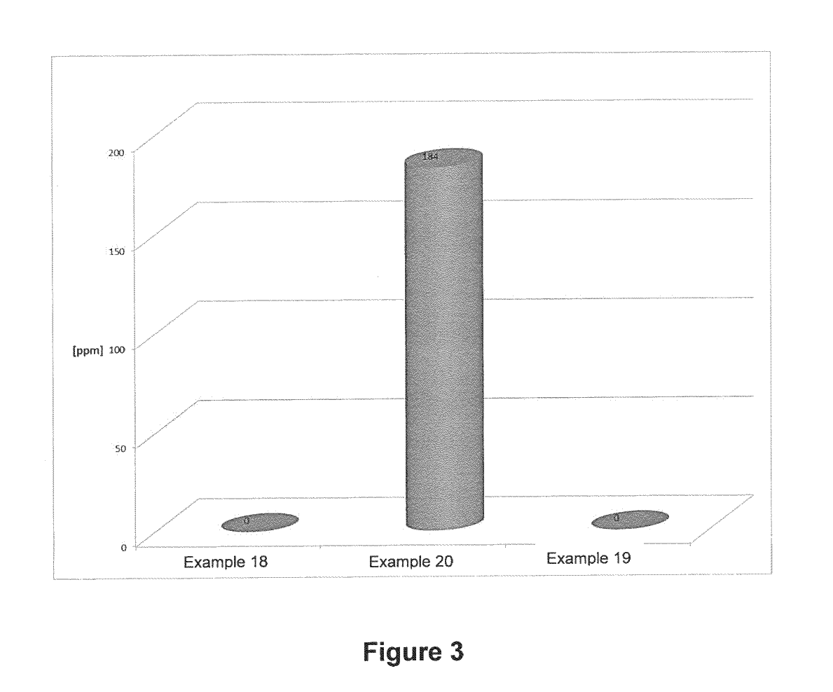

The VOC results are graphically represented in FIG. 2 and the FOG results are graphically represented in FIG. 3.

From the results it can be seen that the stabilising composition according to the present invention (Example 19) provides no detectable contribution to VOC or FOG. Conversely, the current commercial stabilising composition (Example 20) significantly increases the VOC and FOG of the polyurethane foam.

### Examples 21 and 22

Two high density polyurethane foam samples were formed with reduced amounts of water (see table 3) for making polyurethane foam with density of 40 kg/m³.

The first foam sample had 0.4% w/w of a stabilising composition formed from Anox® 1315 and NL438L in a ratio of 2:1 added thereto (Example 21). The second foam sample had 0.4% w/w of a stabilising composition formed from Naugard® PS48 and Naugard® PS30 added thereto, and acted as a comparative example (Example 22).

The amount of volatile organic compounds (VOCs) and Fogging attributed to the stabilizing compositions were measured for each of the polyurethane foam samples according to standard test method VDA 278. The results are shown in Table 13.

TABLE 13

| Example | VOC (ppm) | FOG (ppm) |
|---|---|---|
| 21 | 1 | 92 |
| 22 | 36 | 685 |

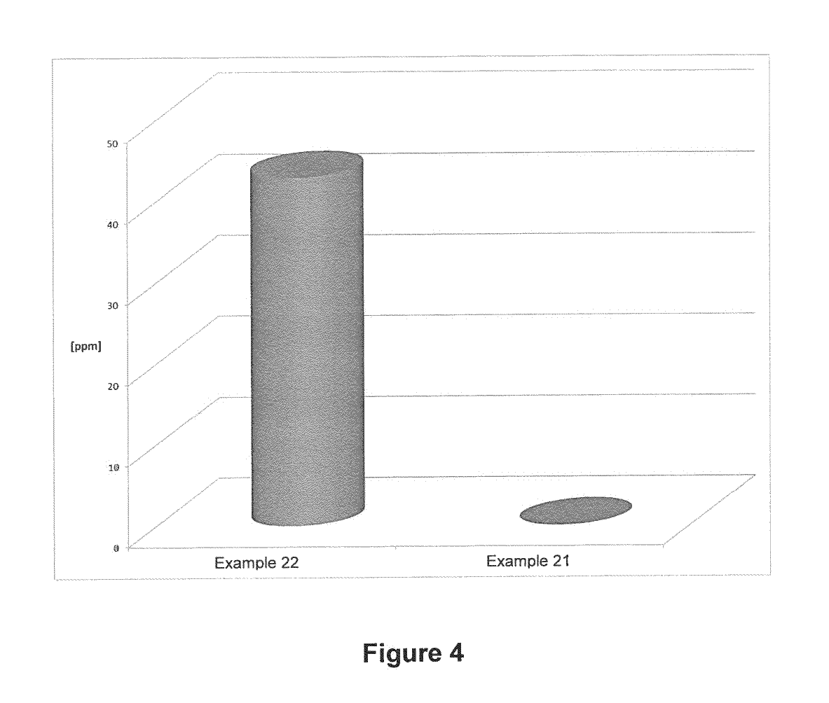

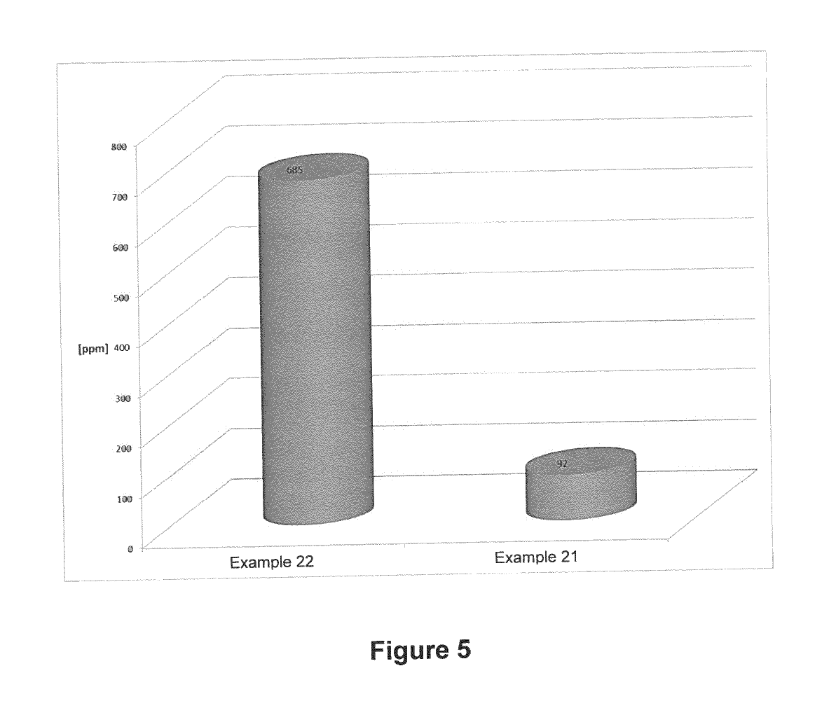

The VOC results are graphically represented in FIG. 4 and the FOG results are graphically represented in FIG. 5.

From the results it can be seen that the stabilising composition according to the present invention (Example 21) has significantly lower VOC and FOG values compared to the current commercial stabilising composition (Example 22).

1. A stabilising composition for polymeric materials, comprising:
at least one secondary arylamine having the formula I: 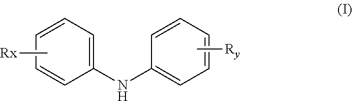
wherein:
each R, independently denotes a hydrocarbyl group having at least 5 carbon atoms, the hydrocarbyl group may or may not be substituted;
x and y are each independently from 0 to 5 provided that at least one of x and y is at least 1; and
a phenolic antioxidant,
the composition or the secondary arylamine being a liquid at ambient conditions and being substantially free from diphenylamine and/or from lower alkylated diphenylamine antioxidants.

2. A stabilising composition according to claim 1, wherein the hydrocarbyl group has at least 6 carbon atoms, at least 7 carbon atoms, at least 8 carbon atoms or at least 9 carbon atoms.

3. A stabilising composition according to claim, wherein the lower alkylated diphenylamine antioxidants are C₄ and below; C₃ and below; C₂ and below; C₁, or mixtures thereof.

4. A stabilising composition according to claim 1, wherein at least one of x or y is more than zero, and wherein x and y are each independently:
a. from 0 to 4;
b. from 0 to 3;
c. from 0 to 2; or
d. 1.

5. A stabilising composition according to claim 4, wherein x and y are the same.

6. A stabilising composition according to claim 5, wherein x and y are each 1.

7. A stabilising composition according to claim 1, wherein the stabilising composition is substantially free from diphenylamine and from lower alkylated diphenylamine antioxidants.

8. A stabilising composition according to claim 1, wherein the stabilising composition is substantially free from t-butylated diphenylamines.

9. A stabilising composition according to claim 1 wherein the stabilizing composition is a liquid at 25° C. and atmospheric pressure.

10. A stabilising composition according to claim 1, wherein the each hydrocarbyl group is an aliphatic hydrocarbyl group.

11. A stabilising composition according to claim 10, wherein each aliphatic hydrocarbyl group is selected from alkyl, alkenyl and alkynyl, wherein each hydrocarbyl group may or may not be substituted with other functional groups, functional linkages, including heteroatoms.

12. A stabilising composition according to claim 11, wherein each aliphatic hydrocarbyl group is selected from alkyl groups, wherein each hydrocarbyl group may or may not be substituted.

13. A stabilising composition according to claim 1, wherein each hydrocarbyl group comprises an aralkyl or an alkaryl group.

14. A stabilising composition according to claim 1, wherein the stabilising composition is substantially free from secondary or tertiary arylamines having vapour pressures above 0.03 Pa at 20° C.

15. A stabilising composition according to claim 1, wherein “substantially free” denotes with respect to an individual component that the component is not present or if present then present in an amount:
a. less than 2% w/w;
b. less than 1.5% w/w;
c. less than 1.0% w/w;
d. less than 0.5% w/w; or
e. less than 0.2% w/w
of the stabilising composition.

16. A stabilising composition according to claim 15, wherein the total amount of any of the individual components present in the composition is:
a. less than 2% w/w;
b. less than 1.5% w/w;
c. less than 1.0% w/w;
d. less than 0.5% w/w; or
e. than 0.2% w/w
of the stabilising composition.

17. A stabilising composition according to claim 1, wherein the phenolic antioxidant has a molecular weight of:
a. at least about 390;
b. at least about 400;
c. at least about 410;
d. at least about 420;
e. at least about 430;
f. at least about 440;
g. at least about 450;
h. at least about 460;
i. at least about 470; or
j. at least about 480.

18. A stabilising composition according to claim 1 wherein the phenolic antioxidant comprises a phenol group which is substituted or substituted twice, if substituted twice then substituted at positions ortho to the —OH group in the phenol.

19. A stabilising composition according to claim 18 wherein each substituent comprises an alkyl group, a branched chain alkyl group, or a t-butyl.

20. A stabilised composition comprising a polyol and a stabilising composition according to claim 1.

21. A stabilised composition comprising a polyurethane and a stabilising composition according to claim

1.

22. A useful article comprising the stabilised composition of claim 20.

23. A process for stabilising a polymeric composition, comprising incorporating or applying the stabilising composition claim 1 to a polyurethane or its precursor.

24. A process for producing a polyurethane, comprising adding the stabilising composition according to claim 1 to a polyol and subsequently reacting with isocyanate to form the polyurethane.

25. Use of the stabilising composition of claim 1 for stabilizing a polyol or polyurethane.
